(19) United States
(12) Patent Application Publication
(10) Pub. No.: US 2019/0087037 A1
(43) Pub. Date: Mar. 21, 2019

(54) TOUCH PANEL AND MOBILE TERMINAL

(71) Applicant: Wuhan China Star Optoelectronics Technology Co., Ltd., Wuhan (CN)

(72) Inventors: Yao-li HUANG, Shenzhen (CN); Xinglong HE, Shenzhen (CN)

(73) Assignee: Wuhan China Star Optoelectronics Technology Co., L td., Wuhan (CN)

(21) Appl. No.: 16/192,830

(22) Filed: Nov. 16, 2018

Related U.S. Application Data
(62) Division of application No. 15/322,536, filed on Dec. 28, 2016.

(51) Int. Cl. G06F 3/044; H04B 1/3827; G06F 3/041; G02F 1/1333

(52) U.S. Cl. CPC G06F 3/044; H04B 1/3833; G06F 3/0414; G02F 2201/503; G02F 2001/13332; G02F 1/133308; G02F 1/13338

(57) ABSTRACT

A touch panel includes a force sensing conductive layer, a separation layer and a fixed metal layer. The separation layer is located between the force sensing conductive layer and the fixed metal layer, so that a capacitance is formed between the force sensing conductive layer and the fixed metal layer. The separation layer includes of a plurality of separation parts, which are separated with one another. The separation parts are each made of an elastic insulation material. A mobile terminal including the touch panel is also provided.

### CROSS REFERENCE

This is a divisional application of co-pending U.S. patent application Ser. No. 15/322,536, filed on Dec. 28, 2016, which is a national stage of PCT Application No. PCT/CN2016/106407, filed on Nov. 18, 2016, claiming foreign priority of Chinese Patent Application No. 201610955214.3, entitled “Touch panel and mobile terminal”, filed on Oct. 27, 2016, the disclosure of which is incorporated herein by reference in its entirety.

### FIELD OF THE INVENTION

The present invention relates to a display technology, and more particularly to a touch panel and a mobile terminal.

### BACKGROUND OF THE INVENTION

The display panel according prior art only has display function. When the pressure touch control function is required, the pressure touch control unit needs to be added on. A certain air space will exist between the force sensing conductive layer and the middle frame in the display panel to form a capacitance. The capacitance is more sensitive to the gap between the force sensing conductive layer and the middle frame. A slight deformation can cause the larger change of the capacitance and seriously affect the realization of the touch control function.

For instance, as the mobile terminal drops or suffers the collision, the air space between the force sensing conductive layer and the middle frame will change, and the touch control function might fail.

### SUMMARY OF THE INVENTION

The present invention provides a touch panel and a mobile terminal, which can prevent the touch function failure due to drop and collision.

The present invention provides a touch panel, comprising a force sensing conductive layer, a separation layer and a fixed metal layer, and the separation layer is located between the force sensing conductive layer and the fixed metal layer, and a capacitance is formed between the force sensing conductive layer and the fixed metal layer, and the separation layer is filled with an elastic insulation material.

The separation layer is filled in with the elastic insulation material.

The separation layer comprises a plurality of separation parts, which are separated with one another, and the separation part is manufactured by the elastic insulation material.

The touch panel further comprises a liquid crystal module and a backlight module, and the liquid crystal module and the backlight module sequentially stack up on the force sensing conductive layer, and the fixed metal layer is located at one side of the force sensing conductive layer away from the backlight module.

The touch panel further comprises a liquid crystal module and a backlight module, and the liquid crystal module and the backlight module sequentially stack up on the separation layer, and the force sensing conductive layer is formed in the liquid crystal module.

The force sensing conductive layer comprises a substrate and a conductive pattern, and the conductive pattern is located on the substrate.

The substrate is a FPC board or a PET board.

A thickness of the separation layer is 0.1 mm to 2 mm, and a thickness of the force sensing conductive layer is 30 nm to 100 nm.

The touch panel further comprises a cover plate, and the cover plate is located at one side of the liquid crystal module away from the backlight module.

The present invention further provides a mobile terminal, comprising any touch panel as aforementioned.

In comparison with prior art, in the touch panel according to the present invention, the separation layer between the force sensing conductive layer and the fixed metal layer is filled with the elastic insulation material When a finger pressed, the force sensing conductive layer still can deform with the elastic property of the elastic insulation material, and according to the capacitance change before and after pressing, the pressure value and the position coordinate of the pressing can be calculated to realize the function of pressure touch control, and when the touch panel dropped or suffered collision, the elastic insulation material filled in the separation layer can effectively act the buffer function, and thus to effectively prevent the deformation of the fixed metal layer. Then, the change of the distance between the force sensing conductive layer and the fixed metal layer can be prevented. Accordingly, the failure of the touch panel can be avoided.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a sectional diagram of a touch panel according to the first embodiment of the present invention;

FIG. 2 is a sectional diagram of the touch panel of FIG. 1 after being pressed;

FIG. 3 is a sectional diagram of a touch panel according to the second embodiment of the present invention;

FIG. 4 is a sectional diagram of the touch panel of FIG. 3 after being pressed;

FIG. 5 is a sectional diagram of a touch panel according to the third embodiment of the present invention;

FIG. 6 is a sectional diagram of the touch panel of FIG. 5 after being pressed;

FIG. 7 is a sectional diagram of a touch panel according to the fourth embodiment of the present invention;

FIG. 8 is a sectional diagram of the touch panel of FIG. 7 after being pressed.

### DETAILED DESCRIPTION OF PREFERRED EMBODIMENTS

Embodiments of the present invention are described in detail with the technical matters, structural features, achieved objects, and effects with reference to the accompanying drawings as follows. It is clear that the described embodiments are part of embodiments of the present invention, but not all embodiments. Based on the embodiments of the present invention, all other embodiments to those of ordinary skill in the premise of no creative efforts obtained, should be considered within the scope of protection of the present invention.

### Embodiment 1

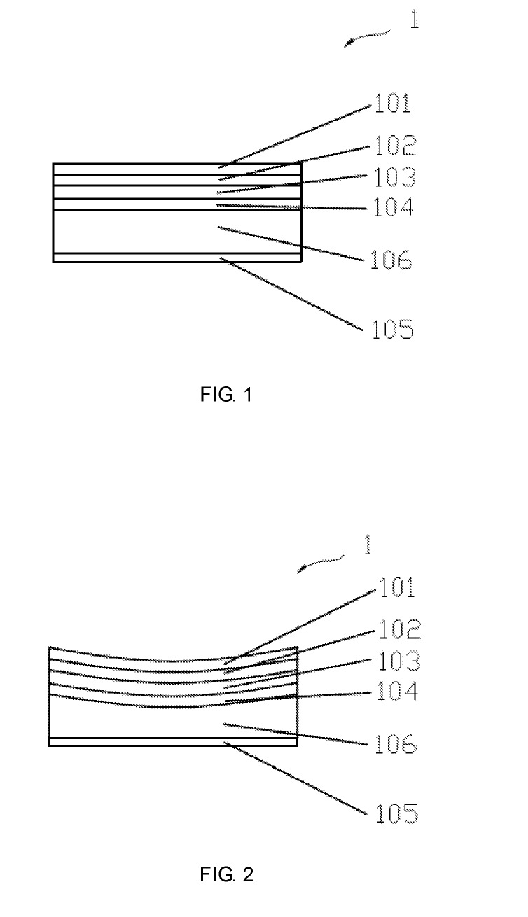

Referring to FIGS. 1 and 2, the touch panel 1 according to a first embodiment of the present invention comprises a cover plate 101, a liquid crystal module 102, a backlight module 103, a force sensing conductive layer 104 and a fixed metal layer 105, wherein the cover plate 101 is located at one side of the liquid crystal module 102 away from the backlight module 103, and the liquid crystal module 102 and the backlight module 103 sequentially stack up on the force sensing conductive layer 104, and the fixed metal layer 105 is located at one side of the force sensing conductive layer 104 away from the backlight module 103, and the fixed metal layer 105 can be the metal middle frame of the touch panel 1 for illustration, and a capacitance is formed between the force sensing conductive layer 104 and the fixed metal layer 105, and a separation layer 106 is located between the force sensing conductive layer 104 and the fixed metal layer 105, and the separation layer 106 is filled with an elastic insulation material.

In this embodiment, the separation layer 106 is filled in with the elastic insulation material. Preferably, the elastic insulation material can be foam, silicon glue or rubber glue. Because what is filled in the separation layer 106 is the elastic insulation material, the capacitance still can be formed between the force sensing conductive layer 104 and the fixed metal layer 105. In FIG. 2, when a finger pressed the cover plate 101, the force sensing conductive layer 104 still can deform with the elastic property of the elastic insulation material, and according to the capacitance change before and after pressing, the pressure value and the position coordinate of the pressing can be calculated to realize the function of pressure touch control, and when the touch panel 1 dropped or suffered collision, the elastic insulation material filled in the separation layer 106 can effectively act the buffer function, and thus to effectively prevent the deformation of the fixed metal layer 105. Then, the change of the distance between the force sensing conductive layer 104 and the fixed metal layer 105 can be prevented. Accordingly, the failure of the touch panel 1 can be avoided.

Furthermore, the force sensing conductive layer 104 comprises a substrate (not shown) and a conductive pattern (not shown), and the substrate is a FPC (Flexible Printed Circuit) board or a PET (Polyethylene-terephthalate) board, and the conductive pattern is manufactured by metal, such as copper or silver, and the conductive pattern is formed by spraying, printing or photolithography, and preferably, a thickness of the force sensing conductive layer 104 is 30 nm to 100 nm. Therefore, the thickness of the force sensing conductive layer 104 is smaller, and has less influence to the thickness of the touch panel 1.

### Embodiment 2

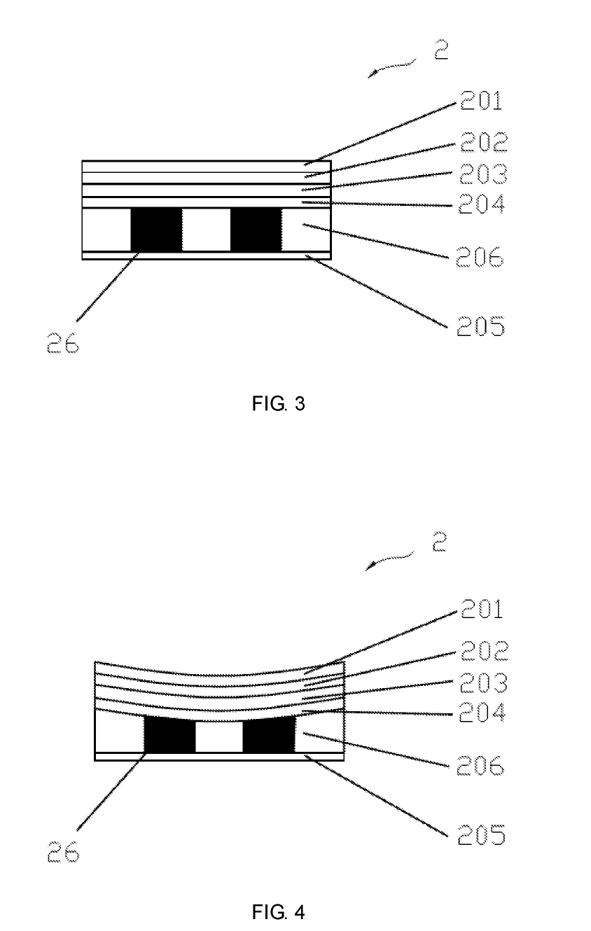

Referring to FIGS. 3 and 4, the touch panel 2 according to the second embodiment of the present invention comprises a cover plate 201, a liquid crystal module 202, a backlight module 203, a force sensing conductive layer 204 and a fixed metal layer 205, wherein the cover plate 201 is located at one side of the liquid crystal module 202 away from the backlight module 203, and the liquid crystal module 202 and the backlight module 203 sequentially stack up on the force sensing conductive layer 204, and the fixed metal layer 205 is located at one side of the force sensing conductive layer 204 away from the backlight module 203, and the fixed metal layer 205 can be the metal middle frame of the touch panel 2 for illustration, and a capacitance is formed between the force sensing conductive layer 204 and the fixed metal layer 205, and a separation layer 206 is located between the force sensing conductive layer 204 and the fixed metal layer 205, and the separation layer 206 is filled with an elastic insulation material.

In this embodiment, the separation layer 206 comprises a plurality of separation parts 26, which are separated with one another, and the separation part 26 is manufactured by the elastic insulation material. Preferably, the elastic insulation material can be foam, silicon glue or rubber glue. Because what is filled in the separation layer 206 is the elastic insulation material, the capacitance still can be formed between the force sensing conductive layer 204 and the fixed metal layer 205. In FIG. 4, when a finger pressed the cover plate 201, the force sensing conductive layer 204 still can deform with the elastic property of the elastic insulation material, and according to the capacitance change before and after pressing, the pressure value and the position coordinate of the pressing can be calculated to realize the function of pressure touch control, and when the touch panel 2 dropped or suffered collision, the elastic insulation material filled in the separation layer 206 can effectively act the buffer function, and thus to effectively prevent the deformation of the fixed metal layer 205. Then, the change of the distance between the force sensing conductive layer 204 and the fixed metal layer 205 can be prevented. Accordingly, the failure of the touch panel 2 can be avoided. Besides, the separation layer 206 is partially filled with the elastic insulation material, and the cost can be saved.

Furthermore, the force sensing conductive layer 204 comprises a substrate (not shown) and a conductive pattern (not shown), and the substrate is a FPC (Flexible Printed Circuit) board or a PET (Polyethylene-terephthalate) board, and the conductive pattern is manufactured by metal, such as copper or silver, and the conductive pattern is formed by spraying, and preferably, a thickness of the force sensing conductive layer 204 is 30 nm to 100 nm. Therefore, the thickness of the force sensing conductive layer 204 is smaller, and has less influence to the thickness of the touch panel 2.

### Embodiment 3

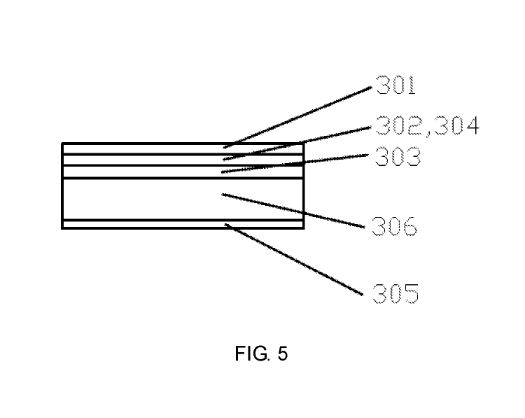

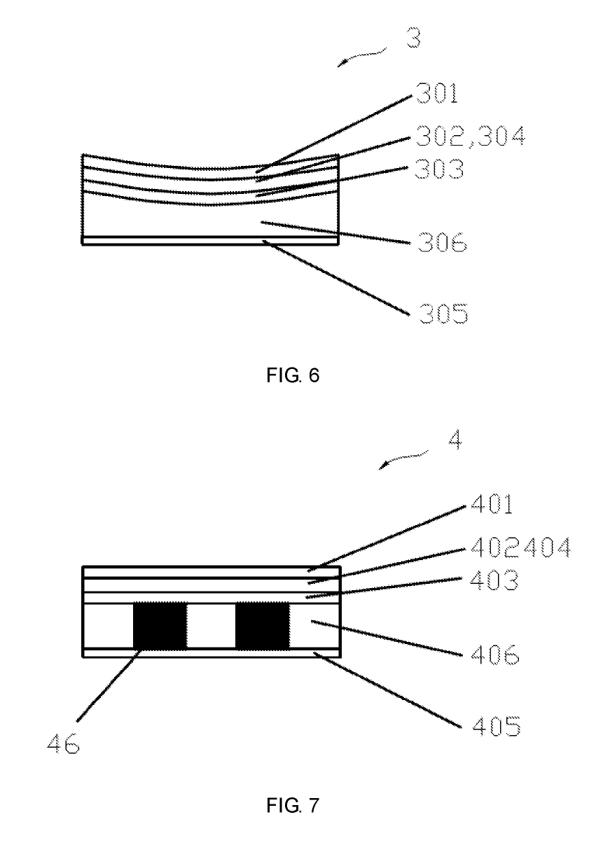

Referring to FIGS. 5 and 6, which show the touch panel 3 according to the third embodiment of the present invention, the touch panel 3 is an embedded touch panel. The touch panel 3 comprises a cover plate 301, a liquid crystal module 302, a backlight module 303, a force sensing conductive layer 304 and a fixed metal layer 305, wherein the cover plate 301 is located at one side of the liquid crystal module 302 away from the backlight module 303, and the liquid crystal module 302 and the backlight module 303 sequentially stack up on the force sensing conductive layer 304, and the fixed metal layer 305 is located at one side of the force sensing conductive layer 304 away from the backlight module 303, and the fixed metal layer 305 can be the metal middle frame of the touch panel 3 for illustration, and a capacitance is formed between the force sensing conductive layer 304 and the fixed metal layer 305, and a separation layer 306 is located between the force sensing conductive layer 304 and the fixed metal layer 305, and the separation layer 306 is filled with an elastic insulation material.

In this embodiment, the separation layer 306 is filled in with the elastic insulation material. Preferably, the elastic insulation material can be foam, silicon glue or rubber glue. Because what is filled in the separation layer 306 is the elastic insulation material, the capacitance still can be formed between the force sensing conductive layer 304 and the fixed metal layer 305. In FIG. 6, when a finger pressed the cover plate 301, the force sensing conductive layer 304 still can deform with the elastic property of the elastic insulation material, and according to the capacitance change before and after pressing, the pressure value and the position coordinate of the pressing can be calculated to realize the function of pressure touch control, and when the touch panel 3 dropped or suffered collision, the elastic insulation material filled in the separation layer 306 can effectively act the buffer function, and thus to effectively prevent the deformation of the fixed metal layer 305. Then, the change of the distance between the force sensing conductive layer 304 and the fixed metal layer 305 can be prevented. Accordingly, the failure of the touch panel 3 can be avoided.

Furthermore, the force sensing conductive layer 304 comprises a substrate (not shown) and a conductive pattern (not shown), and the substrate is a FPC (Flexible Printed Circuit) board or a PET (Polyethylene-terephthalate) board, and the conductive pattern is manufactured by metal, such as copper or silver, and the conductive pattern is formed by spraying, and preferably, a thickness of the force sensing conductive layer 304 is 30 nm to 100 nm. Therefore, the thickness of the force sensing conductive layer 304 is smaller, and has less influence to the thickness of the touch panel 3.

### Embodiment 4

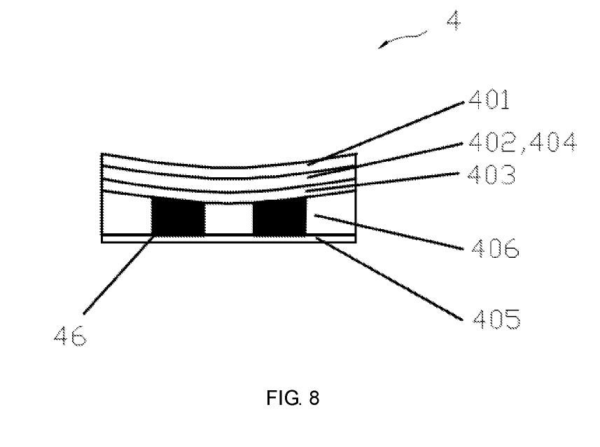

Referring to FIGS. 7 and 8, which show the touch panel 4 according to the third embodiment of the present invention, the touch panel 4 is an embedded touch panel. The touch panel 4 comprises a cover plate 401, a liquid crystal module 402, a backlight module 403, a force sensing conductive layer 404 and a fixed metal layer 405, wherein the cover plate 401 is located at one side of the liquid crystal module 402 away from the backlight module 403, and the liquid crystal module 402 and the backlight module 403 sequentially stack up on the force sensing conductive layer 404, and the fixed metal layer 405 is located at one side of the force sensing conductive layer 404 away from the backlight module 403, and the fixed metal layer 405 can be the metal middle frame of the touch panel 4 for illustration, and a capacitance is formed between the force sensing conductive layer 404 and the fixed metal layer 405, and a separation layer 406 is located between the force sensing conductive layer 404 and the fixed metal layer 405, and the separation layer 406 is filled with an elastic insulation material.

In this embodiment, the separation layer 406 comprises a plurality of separation parts 46, which are separated with one another, and the separation part 46 is manufactured by the elastic insulation material. Preferably, the elastic insulation material can be foam, silicon glue or rubber glue. Because what is filled in the separation layer 406 is the elastic insulation material, the capacitance still can be formed between the force sensing conductive layer 404 and the fixed metal layer 405. In FIG. 8, when a finger pressed the cover plate 401, the force sensing conductive layer 404 still can deform with the elastic property of the elastic insulation material, and according to the capacitance change before and after pressing, the pressure value and the position coordinate of the pressing can be calculated to realize the function of pressure touch control, and when the touch panel 4 dropped or suffered collision, the elastic insulation material filled in the separation layer 406 can effectively act the buffer function, and thus to effectively prevent the deformation of the fixed metal layer 405. Then, the change of the distance between the force sensing conductive layer 404 and the fixed metal layer 405 can be prevented. Accordingly, the failure of the touch panel 4 can be avoided. Besides, the separation layer 406 is partially filled with the elastic insulation material, and the cost can be saved.

Furthermore, the force sensing conductive layer 404 comprises a substrate (not shown) and a conductive pattern (not shown), and the substrate is a FPC (Flexible Printed Circuit) board or a PET (Polyethylene-terephthalate) board, and the conductive pattern is manufactured by metal, such as copper or silver, and the conductive pattern is formed by spraying, and preferably, a thickness of the force sensing conductive layer 404 is 30 nm to 100 nm. Therefore, the thickness of the force sensing conductive layer 404 is smaller, and has less influence to the thickness of the touch panel 4.

The touch panel provided by the present invention can be utilized in kinds of mobile terminals. For instance, the mobile terminals can comprise an user equipment communicating with one or more core webs via a wireless access network RAN. The user equipment can be a mobile phone (cellular phone), a computer having a mobile terminal. Moreover, the user equipment can be a mobile device which is portable, in pocket, handheld, or set in the computer or a car. They switch the audio and or data with the wireless access network. For example, the mobile terminals can comprise the cell phone, the tablet, the personal digital assistant (PDA), a point of sale (POS) or a vehicle computer.

Above are embodiments of the present invention, which does not limit the scope of the present invention. Any modifications, equivalent replacements or improvements within the spirit and principles of the embodiment described above should be covered by the protected scope of the invention.

What is claimed is:

1. A touch panel, comprising a force sensing conductive layer, a separation layer and a fixed metal layer, wherein the separation layer is located between the force sensing conductive layer and the fixed metal layer, such that a capacitance is formed between the force sensing conductive layer and the fixed metal layer;
wherein the separation layer comprises a plurality of separation parts, which are separated with one another, and the separation parts are each made of an elastic insulation material.

2. The touch panel according to claim 1 further comprising a liquid crystal module and a backlight module, wherein the backlight module and the liquid crystal module are sequentially stacked on the force sensing conductive layer, and the fixed metal layer is arranged on one side of the force sensing conductive layer that is distant from the backlight module.

3. The touch panel according to claim 1, wherein the force sensing conductive layer comprises a substrate and a conductive pattern, which is arranged on the substrate.

4. The touch panel according to claim 3, wherein the substrate comprises a flexible printed circuit (FPC) board or a polyethylene terephthalate (PET) board.

5. The touch panel according to claim 1, wherein a thickness of the separation layer is 0.1 mm to 2 mm, and a thickness of the force sensing conductive layer is 30 nm to 100 nm.

6. The touch panel according to claim 2 further comprising a cover plate, which is arranged on one side of the liquid crystal module that is distant from the backlight module.

7. A mobile terminal, comprising the touch panel according to claim 1.
